(19) United States
(12) Patent Application Publication
(10) Pub. No.: US 2015/0007230 A1
(43) Pub. Date: Jan. 1, 2015

(54) METHODS AND SYSTEMS FOR CUSTOMIZING AN INTERACTIVE MEDIA GUIDE WITH ADDITIONAL INFORMATION

(71) Applicant: United Video Properties, Inc., Santa Clara, CA (US)

(72) Inventor: Yuri Bulava, Tomsk City (RU)

(21) Appl. No.: 13/931,404

(22) Filed: Jun. 28, 2013

(51) Int. Cl. H04N 21/472; H04N 21/482

(52) U.S. Cl. CPC H04N 21/47205; H04N 21/4821
USPC 725/41; 725/43

(57) ABSTRACT

Methods and systems are described herein for a media guidance application, which allows a user to quickly and easily review, navigate, and select available media listings. The media guidance application allows a user to customize a media guide such that different types of information are displayed in different regions of a display screen. For example, the media guidance application may allow a user to view media listings in one region of the display screen, while viewing additional information about selected media listings in a second region of the display screen.

### BACKGROUND

In conventional systems, a user typically has many program choices available at any one time. As a user is unlikely to know the content of each program, program guides have been developed to present the available programs in an ordered manner. Typical program guides present available programs in a list or grid usually by the channel on which the program is being presented. As the number of channels or programs are too numerous to fit on any one screen, program guides typically allow a user to vertically scroll through different screens displaying the available programs or channels. However, vertically scrolling through multitudes of programs and channels is inherently slow and does not allow a user to easily compare available programs before selecting a program to watch.

### SUMMARY

Accordingly, methods and systems are described herein for a media guidance application, which allows a user to quickly and easily review, navigate, and select available media listings. Specifically, the media guidance application allows a user to customize a media guide such that different types of information are displayed in different regions of a display screen. For example, the media guidance application may allow a user to view media listings in one region of the display screen, while viewing additional information about selected media listings in a second region of the display screen.

In one aspect, the media guidance application responds to user input associating media listings, for example, selected from a plurality of media listings in a first region, with user selected positions in a second region. The media guidance application then generates for simultaneous display additional information such as previews, video data, textual descriptions, or data from remote sources (e.g., data posted on social networks that is related to the media listing) in the user selected positions associated with each media listing. For example, in some aspects, the media guidance application may receive the additional information corresponding to the media listings from a remote source, store that additional information, and retrieve that additional information in response to the user input.

For example, the media guidance application may generate a plurality of media listings for display in a first region, and receive a first user input selecting a first media listing of the plurality of media listings to associate with a first user selected position in a second region, which is adjacent to the first region, and a second user input selecting a second media listing of the plurality of media listings to associate with a second user selected position in the second region. In response to the first user input, the media guidance application may generate for display additional information corresponding to the first media listing at the first user selected position in the second region, and in response to the second user input, the media guidance application may generate for display, simultaneously with the additional information corresponding to the first media listing at the first user selected position in the second region, additional information corresponding to the second media listing at the second user selected position in the second region.

In another aspect, the media guidance application may determine a type of the additional information corresponding to the first media listing to generate in the second region based on the first user input. For example, the media guidance application may receive a user request to display a particular type of additional information (e.g., a preview) associated with the selected media listing. In another aspect, the media guidance application may determine a type of the additional information corresponding to the first media listing to generate in the second region based on the first user selected position. For example, the user may associate the media listings with a particular user selected position, in which the user selected position is associated with a particular type of additional information (e.g., a content feed from a remote source).

In some aspects, the media guidance application may in response to receiving the first user input selecting the first media listing, determine a size of the second region, and automatically resize the first region based on the size of the second region. For example, the media guidance application may generate the first region in a particular size, upon receiving a user input to associate a media listing with a second region (e.g., in order to receive additional information about the media listing), the media guidance application may resize (e.g., shrink) the first region (e.g., in order to fit both the first region and the second region in the display screen). In some aspects, the media guidance application may additionally or alternatively, determine a first size of the second region based on a type of additional information generated for display in the second region. For example, if the additional information includes textual descriptions, the media guidance application may increase the size of the second region in order to allow the text within the second region to be displayed in a larger size.

In some aspects, the media guidance application may receive a user request to generate the second region. For example, the media guidance application may receive a user input indicating that the user would like to view media listings displayed in a first region, while other information/operations are displayed in a second region. Alternatively, the media guidance application may generate the second region in response to a user input associating a media listing with a user selected position (e.g., dragging and dropping the media listing at a particular user selected position or anywhere outside the first region).

It should be noted, the systems and/or methods described above may be applied to, or used in accordance with, other systems and/or methods as described below.

### BRIEF DESCRIPTION OF DRAWINGS

The above and other objects and advantages of the disclosure will be apparent upon consideration of the following detailed description, taken in conjunction with the accompanying drawings, in which like reference characters refer to like parts throughout, and in which:

FIG. 1A shows an illustrative example of a media guidance application that may be used to display media listings in accordance with some embodiments of the disclosure;

FIG. 1B shows an illustrative example of a media guidance application that may be used to display media listings and/or additional information in different regions in accordance with some embodiments of the disclosure;

FIG. 1C shows an illustrative example of the media guidance application in FIG. 1B after additional information associated with a first media listing has been generated for display in a second region in accordance with some embodiments of the disclosure;

FIG. 1D shows an illustrative example of the media guidance application in FIG. 1C after additional information associated with a second media listing has been generated for display, simultaneously with additional information associated with a first media listing, in a second region in accordance with some embodiments of the disclosure;

FIG. 2A shows an illustrative example of a media guidance application that may be used to customize a media guidance application in accordance with some embodiments of the disclosure;

FIG. 2B shows an illustrative example of the media guidance application in FIG. 2A being used to customize the content displayed in different regions in accordance with some embodiments of the disclosure;

FIG. 2C shows an illustrative example of the media guidance application in FIG. 2A being used to customize the layout of different regions in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 is a flowchart of illustrative steps for generating additional information associated with media listings in a different region; and

FIG. 6 is a flowchart of illustrative steps for automatically selecting and positioning additional information associated with a media listing in accordance with some embodiments of the disclosure.

### DETAILED DESCRIPTION

Accordingly, methods and systems are described herein for a media guidance application, which allows a user to quickly and easily review, navigate, and select available media listings. Specifically, the media guidance application allows a user to customize a media guide such that different types of information are displayed in different regions of a display screen. For example, the media guidance application may allow a user to view media listings in one region of the display screen, while viewing additional information about selected media listings in a second region of the display screen.

An application that allows a user to navigate, compare, select, and/or access media through an interface is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content, for example, in a media guide.

As referred to herein, a “media guide” is a composition of available media assets provided to a user in a human-readable format. For example, a media guide may include a grid (e.g., listings times and content providers offering media assets), a mosaic display of various available media assets, and/or other compilations of media listings.

As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens.

In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a website), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

A media guidance application may generate for display additional information. As referred to herein, “additional information” should be understood to mean any data (including media guidance data) related to selected content, such as a media asset associated with a selected media listing, generated for display in a different region than the content (e.g., a media listing or media asset) that is selected. For example, additional information may include, but is not limited to, any content related to media assets associated with a selected media listing such as video data (e.g., previews, current broadcasts, video clips) or textual data (e.g., textual descriptions about the media asset or information about the content or production of the media asset (e.g., the cast and crew, locations featured in the media asset, trivia about the media asset, advertisement information associated with the media asset, etc.).

For example, in response to one or more user inputs associating one or more media listings (e.g., selected from a plurality of media listings) the media guidance application may generate for display (e.g., on a display device) additional information such as previews, video clips, current broadcasts, textual descriptions, or data from remote sources (e.g., data posted on social networks that is related to the media listing) related to the selected media listings in user selected positions associated with each media listing.

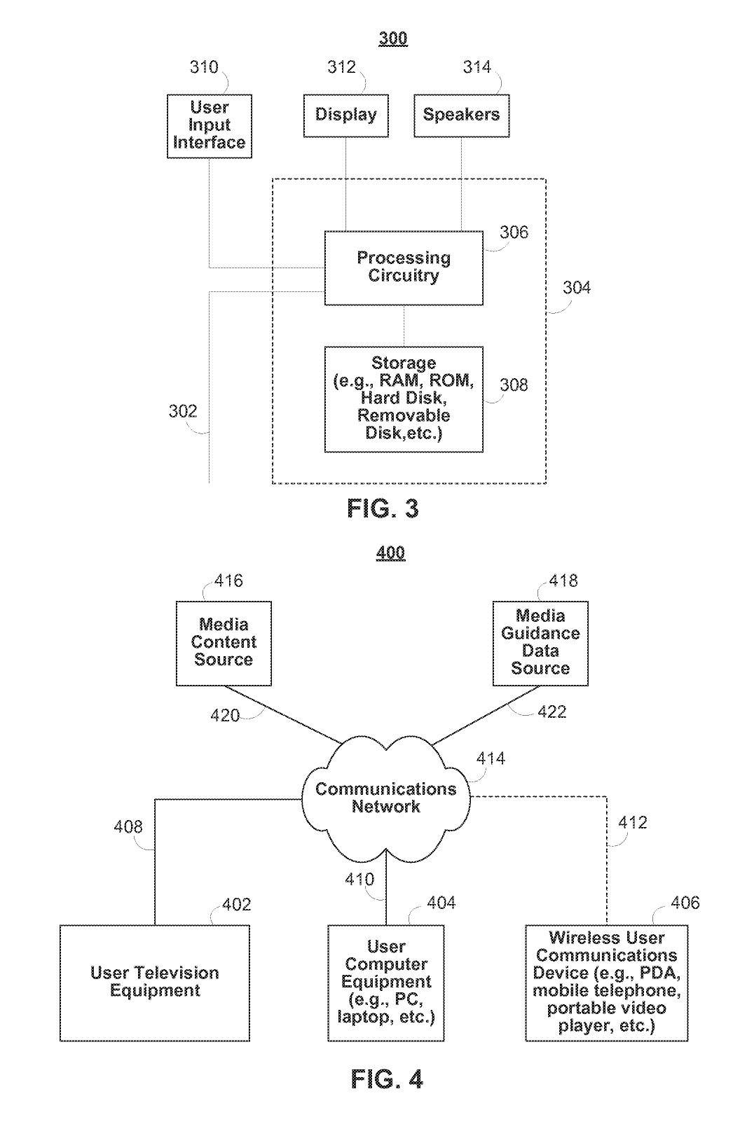

In some embodiments, the additional information may include data stored/received/retrieved from local or remote sources. For example, additional information may be stored/received/retrieved from a local (e.g., storage 308 (FIG. 3) of user device 300 (FIG. 3) or user equipment device 402, 404, and/or 406 (FIG. 4)) or remote (e.g., a database located at media content source 416, media guidance data source 418, and/or any location accessible via communications network 414 (FIG. 4)) location. Additional information may be retrieved/received with a media listing or media asset (e.g., as metadata) that it is related to, or additional information may be retrieved/received separately from the media listing or media asset.

Additional information may include ratings, reviews, microblog posts, user comments, news updates, etc. related to a media listing and/or media asset from various locations in real-time. For example, the media guidance application may receive the additional information corresponding to the media listings from a remote source (e.g., via the Internet), store that additional information, and retrieve that additional information in response to the user input selecting an associated media listing. Additionally or alternatively, the media guidance application may receive a live data feed (e.g., news/sports ticker, social network posts, etc.) related to a user selected media listing/asset from a remote source and display the information obtained from the data feed at a user selected position associated with the media listing/asset.

In some embodiments, the additional information may include operations that may be performed associated with the media listing. For example, the additional information may include playback commands (e.g., pause, play, fast-forward, skip, etc.), ordering options (e.g., pay-per-view purchases), and/or any other options (e.g., editing operations, linking operations, interactive applications, etc.) associated with the media listing/asset and/or display of the media listing/asset. In some embodiments, the media guidance application may determine all operations (or the most frequently used or preferred operations based on a user profile, industry standards, etc.) that are associated with a particular media asset/listing and/or a particular type of media asset/listing. Upon selection of a media asset, the operations may appear in a separate region or overlay.

In some embodiments, the media guidance application may determine a type of the additional information corresponding to the first media listing to generate in the second region based on the first user input. For example, the media guidance application may receive a user request to display a particular type of additional information (e.g., a social media posts by other users viewing the media listing, video clips, etc.) associated with the selected media listing. In another aspect, the media guidance application may determine a type of the additional information corresponding to the first media listing to generate in the second region based on the first user selected position. For example, the user may associate the media listings with a particular user selected position, in which the user selected position is associated with a particular type of additional information (e.g., trailers for the media listing).

In some embodiments, the media guidance application may determine a type of the additional information corresponding to the first media listing to generate in the second region based on a type of a user input. For example, the media guidance application may receive a “swipe” across a user input interface touchscreen. In response to detecting the swipe, the media guidance application may generate a particular type of additional information (e.g., a video clip) corresponding to the selected media asset. Additionally or alternatively, the media guidance application may detect the user is shaking the user device, and in response, generate a different type of additional information (e.g., a textual description), or the media guidance application may detect a right-click on the user input interface, and in response, generate a different type of additional information (e.g., a textual description).

In some embodiments, the media guidance application may determine a type of the additional information corresponding to the first media listing to generate in the second region based on a length of time between inputs. For example, the media guidance application may receive a selection of a media listing. If the media guidance application does not receive another input for a certain period of time (e.g., two seconds), the media guidance application may generate a particular type of additional information (e.g., a blog post retrieve from a social network associated with a user) automatically. Additionally or alternatively, if the media guidance application does not receive another input for a certain period of time (e.g., one second), the media guidance application may generate a different and/or additional type of additional information (e.g., an interactive advertisement) automatically.

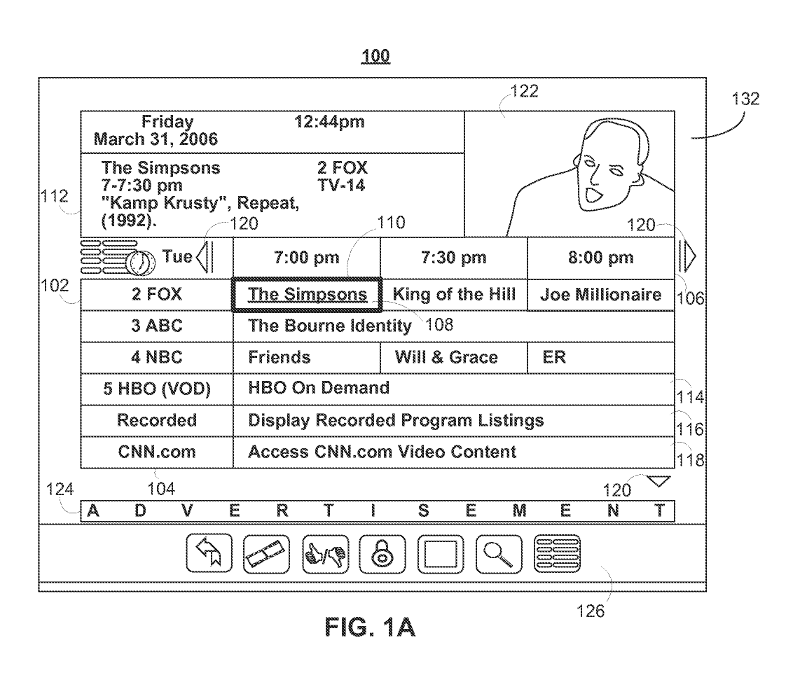

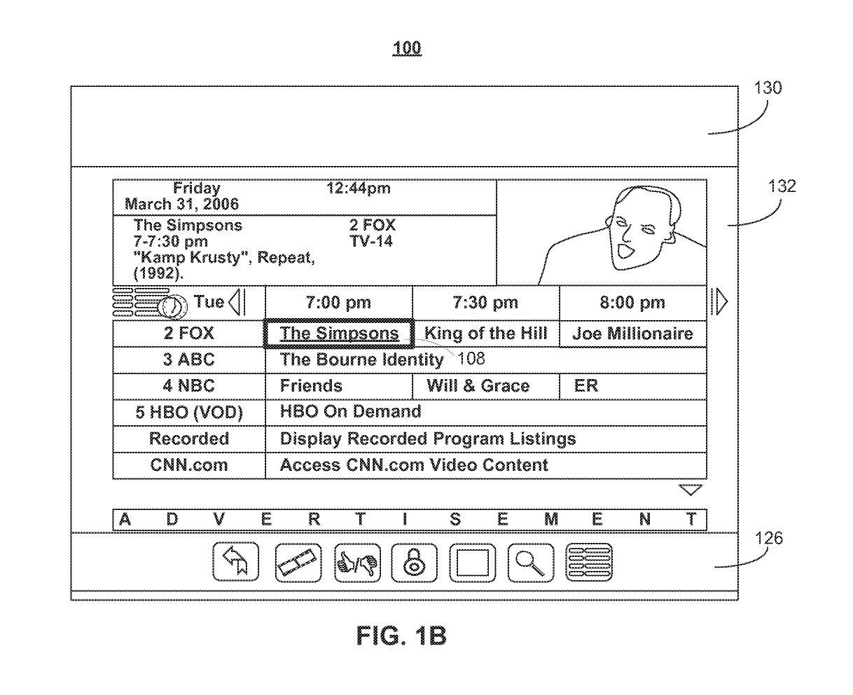

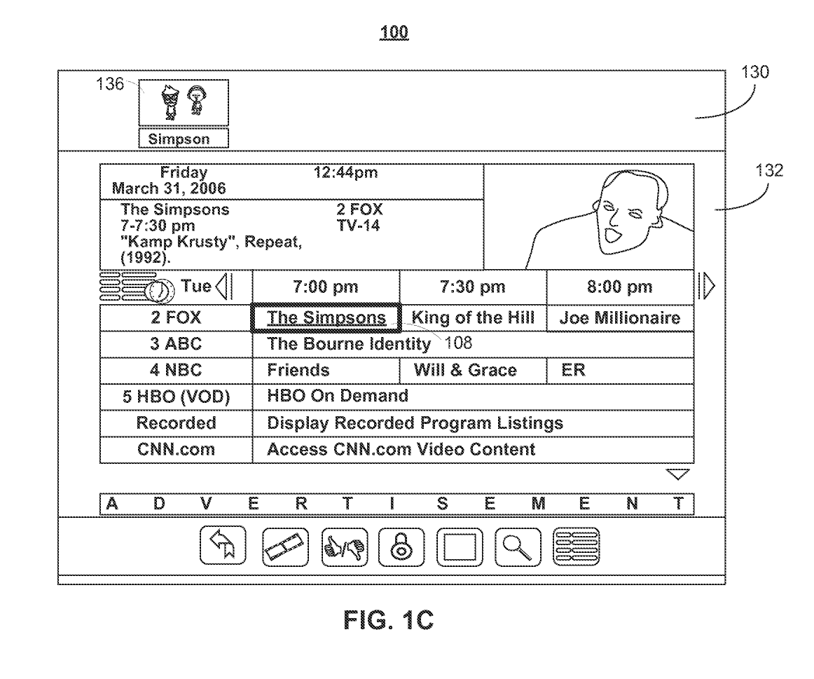

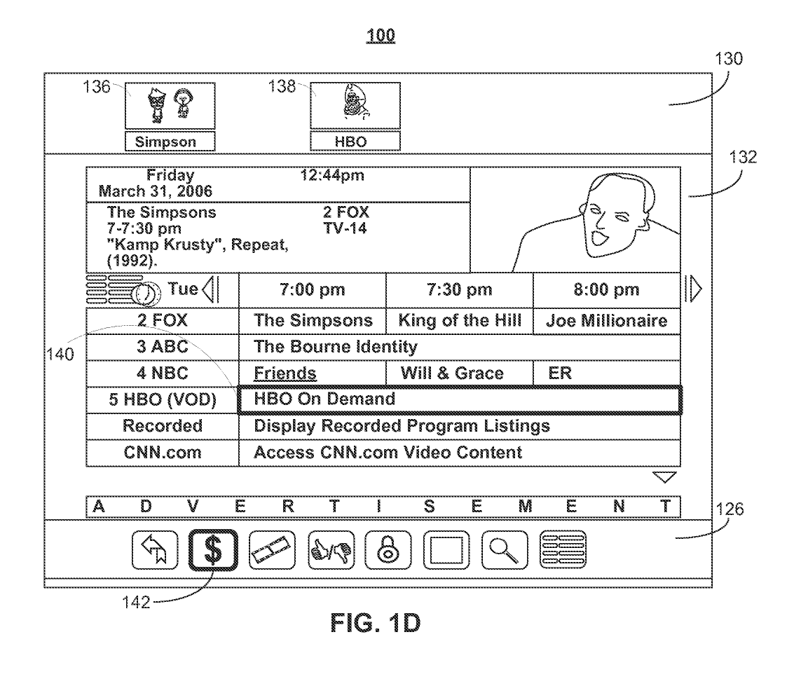

FIGS. 1A-D and 2A-C show illustrative display screens that may be used to provide media guidance data. The display screens shown in FIGS. 1A-D and 2A-C may be implemented on any suitable user equipment device or platform. While the displays of FIGS. 1A-D and 2A-C are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1A shows illustrative grid program listings display 100 arranged by time and channel that also enables access to different types of content in a single display. Display 100 may include first region 132, which in turn includes grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet website or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other websites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

FIG. 1B shows an illustrative example of a media guidance application that may be used to display media listings and/or additional information in different regions. In some embodiments, display 100 of FIG. 1B may represent display 100 of FIG. 1A after a user has instructed the media guidance application to generate different regions.

For example, while accessing the media guidance application to view media listings (e.g., program listing 108 (FIG. 1A)), a user may wish to obtain additional information about one or more media listings. To do so, the user may request that the media guidance application generates a split-screen view in which a portion (e.g., first region 132) is used to view available media listings, while a different portion (e.g., second region 130 and/or options region 126) is used for a different purpose. In response, the media guidance application may segment the display screen into multiple regions.

In FIG. 1B, display 100 has been segmented into three portions (e.g., first region 132, second region 130, and options region 126). In FIG. 1B, first region 132 occupies less screen space (e.g., due to second region 130 now occupying screen space), than first region 132 of FIG. 1A. In order to accommodate all regions in FIG. 1B, the media guidance application has reduced the total screen space of region 132.

In some embodiments, the media guidance application may reduce the size of all regions equally. For example, the media guidance application may reduce each currently displayed region by a particular percentage (e.g., ten percent) in order to accommodate another region. In some embodiments, the media guidance application may adjust the size of a region in all dimensions (e.g., increasing or decreasing the height and width) or may adjust the size of a region in only a single dimension (e.g., increasing or decreasing the height of a region while the width remains constant). For example, as shown in FIG. 1B, the height of region 132 (as compared to region 132 in FIG. 1A) has been decreased, but the width has been maintained.

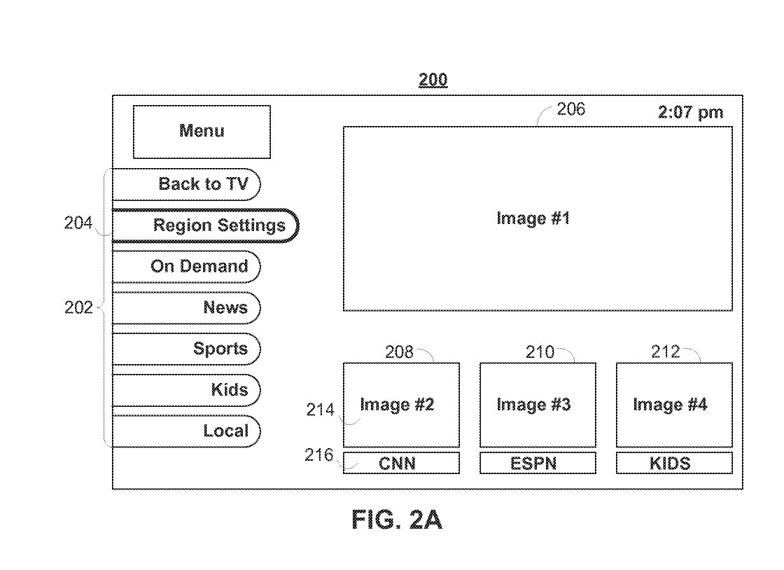

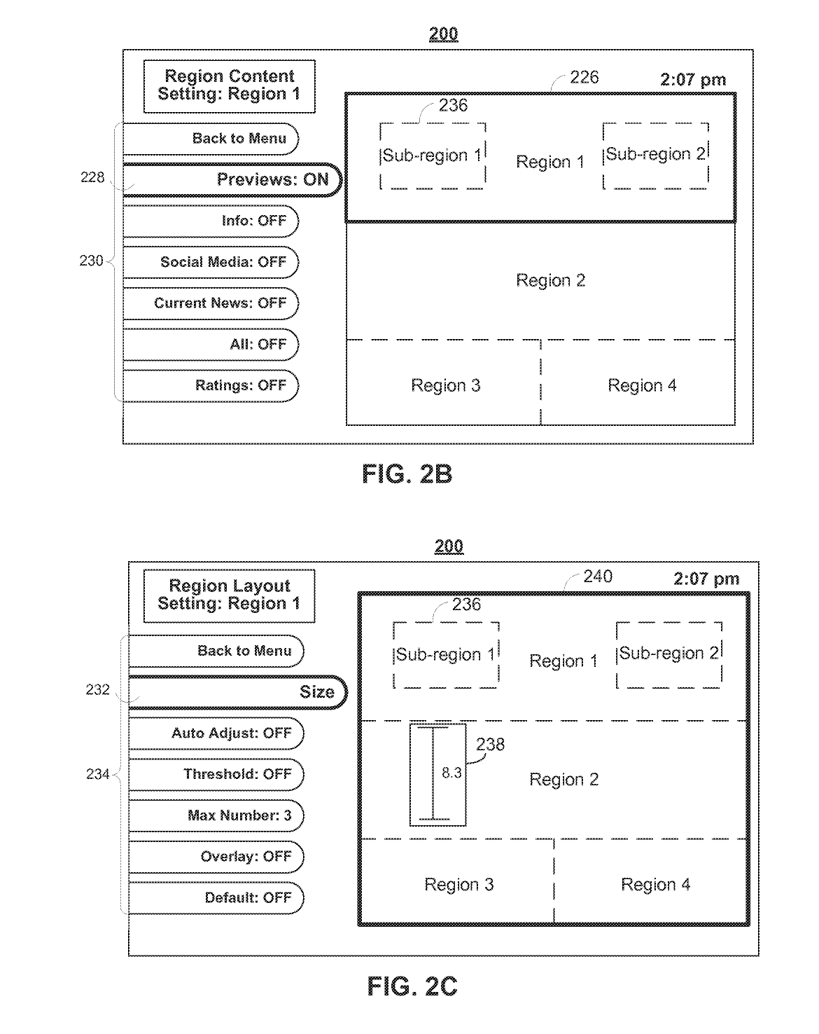

In FIG. 1B, options region 126 has not had its corresponding screen space reduced. For example, in some embodiments, the media guidance application may reduce only some regions in order to accommodate another region. The media guidance application may determine which regions to adjust via user input (e.g., as discussed below in relation to FIG. 2C) or based on threshold levels determined by the type of information (e.g., media guidance data and/or additional information) displayed in the region. For example, the media guidance application may determine that options region 126 is already at its minimum threshold level.

As used herein, a “minimum threshold level” refers to a size at which the information and/or operations generated for display in a particular region are no longer usable by a user. For example, reducing the size of options region 126 may have caused the displayed options to overlap each other preventing a user from selecting a particular option. Likewise, reducing the size of first region 132 below a minimum threshold level may result in the media listings (e.g., program listing 108) to be displayed in a font so small that the media listing becomes illegible.

In some embodiments, the media guidance application may also reduce the amount of information within a region in order to accommodate another region in the display screen. For example, the media guidance application may reduce the number of media listings displayed in region 132 and/or the number of options displayed in options region 126. For example, reducing the number of options in options region 126 may allow the options region to achieve a lower minimum threshold level.

Second region 130, as shown in FIG. 1B, is currently blank; however, in some embodiments, second region 130 may include instructions or other content (e.g., widgets, tools, etc.). For example, upon generating separate regions, the media guidance application may prompt the user for a type of information (e.g., a type of additional information) that should be generated for display in second region 130. Additionally or alternatively, the media guidance application may allow a user to define settings (e.g., as discussed below in relation to FIGS. 2A-C), which govern (e.g., which dictate the type of information shown in a particular region) different regions.

Alternatively or additionally, the media guidance application may generate one or more regions (e.g., options region 126 (FIG. 1B)) as an overlay on top of another region (e.g., first region 132 (FIG. 1B)). Additionally or alternatively, one or more regions may also be generated on a separate device such that multiple devices work in concert to provide a unified media experience for a user.

FIG. 1C shows an illustrative example of the media guidance application of FIG. 1B after additional information associated with a first media listing has been generated for display in a second region. For example, in response to a user input selecting a media listing (e.g., program listing 108 (FIG. 1C)), the media guidance application has generated additional information 136, which corresponds to the selected media listing (e.g., program listing 108 (FIG. 1C)). For example, in FIG. 1C, additional information 136 is video data (e.g., a preview, current broadcast, video clip, interactive content, etc.) associated with the selected media listing.

In some embodiments, the position of additional information 136 may be user selected. For example, the media guidance application may have received a user input dragging and dropping the media listing at the particular position of additional information 136. Alternatively, the media guidance application may have received a user input dragging and dropping the media listing within second region 130 and the position of additional information 136 may have been automatically determined (e.g., additional information 136 may has been assigned the left-most available position).

For example, as the selected media listing (e.g., program listing 108) is dragged across display 100, the media guidance application may monitor its position. When the selected media listing is dragged outside the first region 132, the media guidance application may automatically retrieve additional information 136. For example, as soon as the selected media listing is positioned outside first region 132, the media guidance application may retrieve information (e.g., additional information 136) associated with the selected media listing based on the criteria associated with the currently displayed region. In some embodiments (e.g., when there are more than two regions), information associated with a selected media listing may appear in multiple other regions.

FIG. 1D shows an illustrative example of a media guidance application in FIG. 1B after additional information associated with a second media listing has been generated for display, simultaneously with additional information associated with a first media listing, in a second region.

In FIG. 1D, a different media listing (e.g., on-demand listing 140) is selected. Furthermore, additional information 138 and additional information 142 have been generated in second region 130 and options region 126, respectively. For example, upon the media guidance application determining that the selected media listing (e.g., on-demand listing 140) is outside first region 132, the media guidance application populates the other currently displayed regions with additional information associated with the selected media asset. For example, additional information 138 (e.g., video data associated with the listing) is populated in second region 130, whereas additional information 142 (e.g., an on-demand purchase option) is populated in options region 126.

It should be noted, that in some embodiments, a media listing may only require selection (i.e., not a dragging operation), in order for the media guidance application to populate currently displayed regions with additional information. Furthermore, in some embodiments, the media guidance may automatically generate regions that are not displayed based on the additional information associated with the selected media listing. When the selected media listing is dragged outside the first region 132, the media guidance application may automatically retrieve additional information 136.

In some embodiments, the media guidance application may receive user input freely modifying the position of additional information 136 both within its associated region and outside its associated region. For example, once the additional information has been generated by the media guidance application, the media guidance application, may allow a user to further customize display 100. Alternatively, in some embodiments, the position of additional information 136 may be restricted to pre-defined sub-regions (e.g., as discussed below in relation to FIG. 2C).

Another display arrangement for providing media guidance is shown in FIG. 2A. Video mosaic display 200 includes selectable options 202 for content information organized based on content type, genre, and/or other organization criteria and listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

In display 200, region settings option 204 is selected thus providing options (e.g., as discussed in relation to FIGS. 2B and 2C) related to the various regions generated by the media guidance application. FIGS. 2B and 2C show illustrative examples of ways a user may customize the content and layouts of different regions generated by the media guidance application.

FIG. 2B display 200 includes selectable options 230 for modifying the type of additional information that is associated with a particular region. For example, region 226 is currently highlighted. As such, selectable options 230 allows a user to determine the type of additional information (e.g., additional information 136 (FIG. 1C)) displayed in region 226 (e.g., whether or not “previews,” such as television, movie, and/or other media asset trailers or advertisements related to the selected media listing are displayed; whether or not “info,” such as textual descriptions related to the selected media listing are displayed; whether or not “social media,” such as microblog posts, social media website comments, or user profile information related to the selected media listing is displayed; whether or not “current news,” such as stock, sports, news tickers and/or real-time data feeds related to the selected media listing are displayed; whether or not “all,” such as any additional information available from any source related to the selected media listing is displayed; or “ratings,” such as any user-generated or critical reviews related to the selected media listing are displayed).

In some embodiments, the media guidance application may have default settings (e.g., settings that do not require a user to manually set up user preferences for each region). In some embodiments, the media guidance application may determine user preferences for each region based on monitoring the interaction of the user with the media guidance application.

In FIG. 2B, selectable option 228 is selected thus designating that “previews,” are shown in region 226. For example, in some embodiments, region 226 may correspond to second region 130 (FIG. 1D); thus additional information 136 and additional information 138 correspond to “previews” associated with the selected listings.

Likewise, in FIG. 2C display 200 includes selectable options 234 for modifying the layout of different regions generated by the media guidance application. For example, display screen 240 is currently highlighted indicating that all regions within the display screen are currently being modified. As such, selectable options 234 allows a user to determine the layout of all regions in the display (e.g., display 100 (FIG. 1B)) such as the “size,” (e.g., in metric, pixels, or other units), whether or not the regions will “auto adjust,” (e.g., automatically adjust their respective size based on the additional information generated in their region or other regions); whether or not a “threshold,” such as a minimum threshold level discussed above will be enforced; select a “max number,” such as the maximum number of regions allowed to be generated by the media guidance application; whether or not the media guidance application will generate the regions as overlays by selecting “overlay”; or whether or not the media guidance application will use “default” settings.

In some embodiments, the media guidance application may have default settings (e.g., settings that do not require a user to manually set up user preferences for each region). In some embodiments, the media guidance application may determine user preferences for each region (or display screen) based on monitoring the interaction of the user with the media guidance application.

In FIG. 2C, selectable option 232 is selected thus allowing a user to modify the “size,” of regions in display screen 240. In addition, the media guidance application has generated/accessed tool 238 (e.g., a widget or separate application) to assist the user in modifying the regions of display screen 240.

FIG. 2C also includes sub-region 236. For example, the media guidance application may generate sub-regions within each of the regions. The sub-regions may include additional or alternative rules of the region within which they are located. In some embodiments, the sub-regions may define positions/locations that a user may select for additional information (e.g., additional information 136 (FIG. 2C)).

Users may access content and the media guidance application (and its display screens described above and below) from one or more of their user equipment devices. FIG. 3 shows a generalized embodiment of illustrative user device 300. More specific implementations of user equipment devices are discussed below in connection with FIG. 4. User device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user device 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user device 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user device 300 is retrieved on-demand by issuing requests to a server remote to the user device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a website accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the website www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user device 300. In some embodiments, media guidance applications may be client-server applications where only a client application resides on the user equipment device, and server application resides on a remote server. For example, media guidance applications may be implemented partially as a client application on control circuitry 304 of user device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

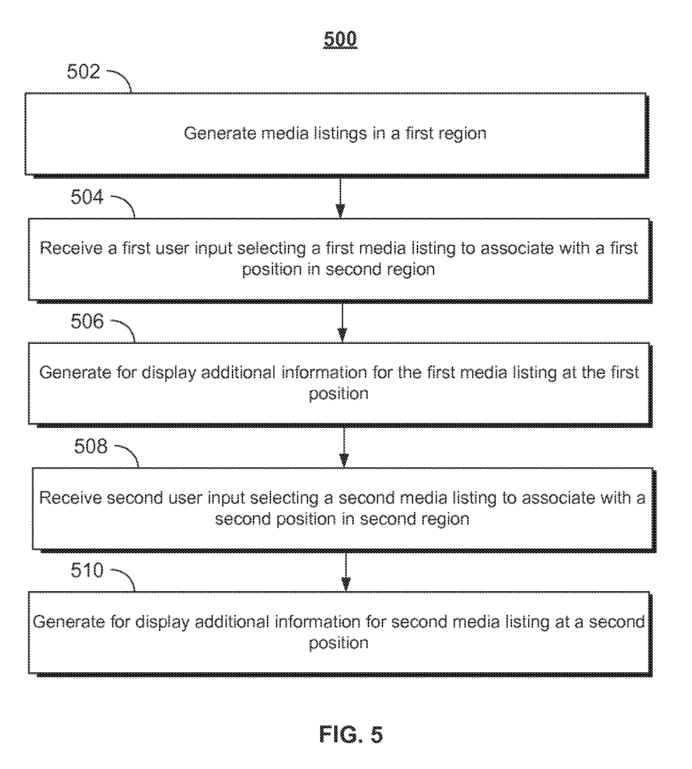

FIG. 5 is a flowchart of illustrative steps for generating additional information associated with media listings. Process 500 may be used to generate the display screens in FIGS. 1A-D and 2A-C. It should be noted that process 500 or any step thereof could be provided by any of the devices shown in FIGS. 3-4. For example, process 500 may be executed by control circuitry 304 (FIG. 3) as instructed by a media guidance application implemented on user equipment device 402, 404, and/or 406 (FIG. 4) to generate for display additional information 136 (FIGS. 1C-D) in a media guide (e.g., as shown in display 200 (FIG. 2A-C)) displayed on a display device (e.g., display 312 (FIG. 3)) accessible by the media guidance application.

At step 502, the media guidance application generates media listings in a first region. For example, the media guidance application may generate a plurality of media listings (e.g., as described in FIG. 1A). The media guidance application may receive media guidance data from media guidance data source 418 (FIG. 4)). Additionally or alternatively, the media guidance application may generate one or more media assets (e.g., as described in FIG. 2A). The media guidance application may receive the media assets from media content source 416 (FIG. 4)) and display the media assets (e.g., via display 312 (FIG. 3)).

At step 504, the media guidance application receives a first user input selecting a first media listing to associate with a first position in a second region. For example, the media guidance application may receive a user input (e.g., via user input interface 310 (FIG. 3)) selecting a media listing (e.g., program listing 108 (FIG. 1C) to associate with a first position (e.g., sub-region 236 (FIG. 2C) of a second region (e.g., second region 130 (FIG. 1B)).

At step 506, the media guidance application generates for display additional information for the first media listing at the first position. For example, the media guidance application may generate a real-time news feed that provides current news or celebrity gossip related to the media asset or cast and crew of the media asset associated with the selected media listing.

At step 508, the media guidance application receives a second user input selecting a second media listing to associate with a second position in a second region. For example, the media guidance application may receive a user input (e.g., via user input interface 310 (FIG. 3)) selecting a media listing (e.g., on-demand listing 140 (FIG. 1D) to associate with a second position (e.g., a sub-region other than sub-region 236 (FIG. 2C)) of the second region (e.g., second region 130 (FIG. 1B)).

At step 510, the media guidance application generates for display additional information for the second media listing at the second position. In some embodiments, the media guidance application may display the additional information for the second media listing simultaneously with the additional information for the first media listing at the first position. In some embodiments, the position at which the additional information for the selected media listings are displayed may be user selected. For example, a user may indicate the particular sub region (e.g., sub-region 236 (FIG. 2C)) that the additional information (e.g., additional information 138 (FIG. 1D)) for a particular media listing should be displayed.

In some embodiments, the media guidance application may generate additional regions with the same or different types of additional information. For example, the media guidance application may generate additional information for (e.g., corresponding to one or more media assets) in a particular region (e.g., region 226 FIG. 2B)). The particular region may include one or more sub-regions (e.g., sub-region 236 (FIG. 2B)). Each sub-region may be associated with unique rules. For example, associating a media listing with a one sub-region may generate different additional information than associating the same media listing with a different sub-region based on the rules associated with the sub-region. Additionally or alternatively, the rules of each sub-region may be unique to each media listing. For example, associating a media listing with a one sub-region may generate a different type of additional information than associating a different media listing with the same sub-region. For example, associating a sports program with a particular sub-region may generate a display of a current broadcast or real-time updates corresponding to the sports program, whereas associating a crime drama program may generate episode summary or trivia information.

In some embodiments, in response to a user input associating the same media listing with different user selected positions (e.g., the positions of additional information 136 and additional information 138 (FIG. 1D)) the media guidance application may simultaneously display different types of additional information about the same media listing. For example, in one position previews for the media listing may be displayed while in another position information related to the cast and crew may be displayed.

In some embodiments, in response to a user input associating different media listings with different user selected positions (e.g., the positions of additional information 136 and additional information 138 (FIG. 1D)) the media guidance application may simultaneously display the same or different types of additional information about the different media listings. For example, in one position subtitles for the first media listing may be displayed while in another position a video interview with an actor in the second media listing may be displayed.

Additionally or alternatively, the media guidance application may generate additional regions for additional information for different media listings. For example, each time a different media listing (e.g., program listing 108 (FIG. 1C)) is associated with a user selected position outside a first region (e.g., first region 132 (FIG. 1C)). The media guidance application may generate a second region (e.g., second region 130 (FIG. 1C)) associated with displaying additional information (e.g., additional information 136 (FIG. 1C)) for the media listing. In some embodiments, in response to a user input associating a different media listing with a different user selected positions (e.g., the positions of additional information 136 and additional information 138 (FIG. 1D)) the media guidance application may simultaneously display the same or different types of additional information about the media listings. For example, in one position, previews for a first media listing may be displayed by the media guidance application while in another position previews for a second media listing may be displayed by the media guidance application. In another example, in one position, previews for a first media listing may be displayed by the media guidance application while in another position links to critical reviews for a second media listing may be displayed by the media guidance application.

It is contemplated that the steps or descriptions of FIG. 5 may be used with any other embodiment of this disclosure. In addition, the steps and descriptions described in relation to FIG. 5 may be done in alternative orders or in parallel to further the purposes of this disclosure. For example, each of these steps may be performed in any order or in parallel or substantially simultaneously to reduce lag or increase the speed of the system or method.

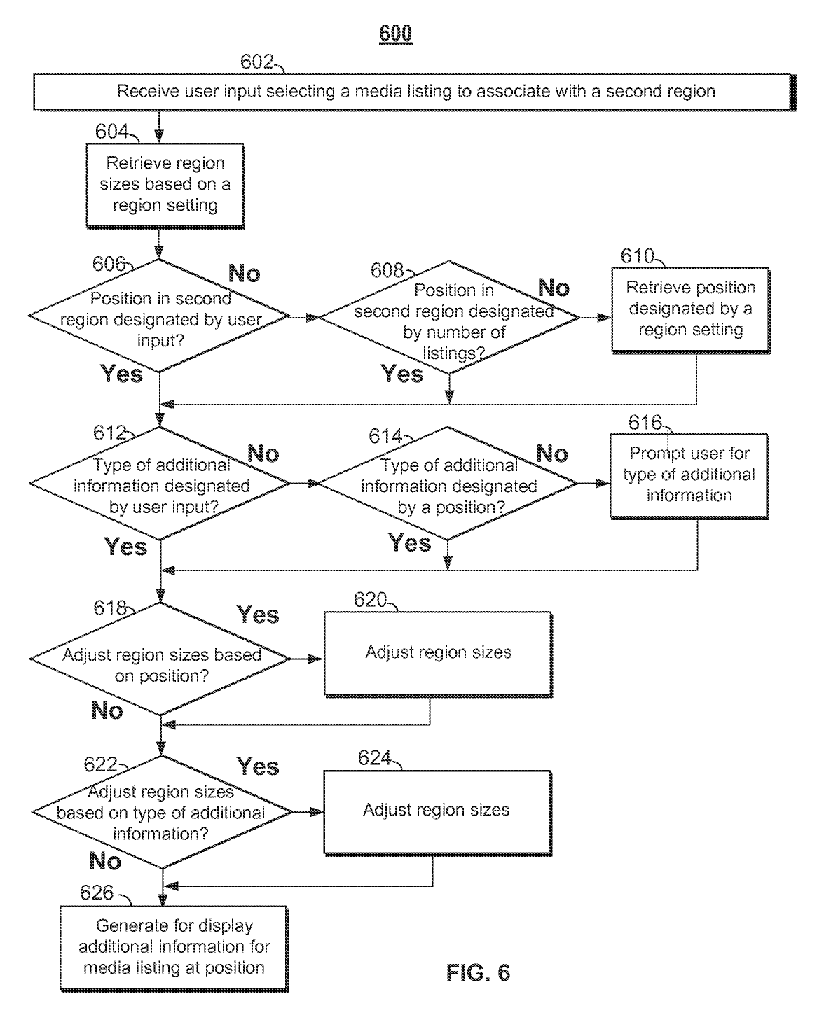

FIG. 6 is a flowchart of illustrative steps for automatically selecting and positioning additional information associated with a media listing. Process 600 may be used to generate the display screens in FIGS. 1A-D and 2A-C. It should be noted that process 600 or any step thereof could be provided by any of the devices shown in FIGS. 3-4. For example, process 600 may be executed by control circuitry 304 (FIG. 3) as instructed by a media guidance application implemented on user equipment device 402, 404, and/or 406 (FIG. 4) to generate for display additional information 136 (FIGS. 1C-D) in a media guide (e.g., as shown in display 200 (FIG. 2A-C)) displayed on a display device (e.g., display 312 (FIG. 3)) accessible by the media guidance application.

At step 602, the media guidance application receives a user input selecting a media listing to associate with a second region. For example, in some embodiments, step 602 may correspond to step 504 or 506 (FIG. 5). For example, the media guidance application may monitor (e.g., via control circuitry 304 (FIG. 3)) user inputs (e.g., received via user input interface 310 (FIG. 3)) indicating a drag and drop operation associated with a media listing (e.g., program listing 108 (FIG. 1A)). For example, as the selected media listing (e.g., program listing 108) is dragged across display 100, the media guidance application may monitor its position. When the selected media listing is dragged outside the first region (e.g., first region 132 (FIG. 1B)), the media guidance application may determine the user is requesting that the media listing be associated with a second region.

At step 604, the media guidance application retrieves region sizes based on region settings. For example, the media guidance application may have default settings or settings based on user preferences (e.g., as discussed above in relation to FIG. 2C) that indicate particular sizes for various regions. The region settings may be retrieves from a local (e.g., storage 308 (FIG. 3) of user equipment device 402, 404, and/or 406 (FIG. 4)) or remote (e.g., a database located at media content source 416, media guidance data source 418, and/or any location accessible via communications network 414 (FIG. 4)) location. The media guidance application may also store a user profile indicating particular settings associated with a current user. In some embodiments, the settings within the user profile may be continuously or periodically updated based on user interactions with the media guidance application.

At step 606, the media guidance application determines whether or not a particular position in the second region is designated by the user as corresponding to the media listing. For example, the media guidance application may have received a user input right-clicking on a media listing and selecting a position via a drop-down menu generated by the media guidance application (e.g., via control circuitry 304 (FIG. 3)). If the media guidance application determines that a particular position in the second region is designated by the user, the media guidance application proceeds to step 612. If the media guidance application determines that a particular position in the second region was not designated by the user input, the media guidance application proceeds to step 608.

At step 608, the media guidance application determines whether or not a particular position in the second region is designated by the number of media listings already associated with the second region. For example, as the media guidance application associates media listings with the second region, the media guidance application may need to modify the position at which the media listing and/or the size and/or shape of the region or sub-region with which the media listing is being associated based on the number of media listings. For example, the media guidance application may center or justify the positions associated with the media listings and/or modify the size or shape (e.g., in order to meet a minimum threshold level). If the media guidance application determines to modify a particular position in the second region based on the number of media listings already associated with the second region, the media guidance application proceeds to step 612. If the media guidance application determines not to modify a particular position in the second region based on the number of media listings already associated with the second region, the media guidance application proceeds to step 610.

At step 610, the media guidance application retrieves a position designated by a region setting. For example, the media guidance application may have default settings or settings based on user preferences (e.g., as discussed above in relation to FIG. 2C) that indicate particular layouts for various regions and/or sub-regions. The region settings may be retrieved from a local (e.g., storage 308 (FIG. 3) of user equipment device 402, 404, and/or 406 (FIG. 4)) or remote (e.g., a database located at media content source 416, media guidance data source 418, and/or any location accessible via communications network 414 (FIG. 4)) location. After retrieving a position designated by a region setting, the media guidance application proceeds to step 612.

At step 612, the media guidance application determines whether or not a particular type of additional information is designated by the user as corresponding to the media listing. For example, the media guidance application may have received a vocal command from a user requesting additional information of a particular type for a selected media asset. If the media guidance application determines that a particular type of additional information is designated by the user, the media guidance application proceeds to step 618. If the media guidance application determines that a particular type of additional information was not designated by the user input, the media guidance application proceeds to step 614.

At step 614, the media guidance application determines whether or not a particular type of additional information is designated by a position associated with the media listing. For example, the media guidance application may be associated with particular types of additional information with particular regions or sub-regions (e.g., as discussed above in relation to FIGS. 2B-C)). For example, associating a media listing with a particular region or sub-region may automatically cause additional information of a particular type to be generated. The region settings associated with a particular region or sub-region may be retrieved from a local (e.g., storage 308 (FIG. 3) of user equipment device 402, 404, and/or 406 (FIG. 4)) or remote (e.g., a database located at media content source 416, media guidance data source 418, and/or any location accessible via communications network 414 (FIG. 4)) location.

If the media guidance application determines a particular type of additional information is designated by a position associated with the media listing, the media guidance application proceeds to step 618. If the media guidance application determines a particular type of additional information is designated by a position associated with the media listing, the media guidance application proceeds to step 616.

At step 616, the media guidance application prompts a user for a type of additional information. For example, if the media guidance application determines that a user has not indicated a particular type of additional information, and the media guidance application determines that a particular type of additional information is not determined based on a position associated with the media listing, the media guidance application prompts the user (e.g., via a pop-up box appearing on display 312 (FIG. 3) and/or an overlay on display 100 (FIG. 1B)), and proceeds to step 618.

At step 618, the media guidance application determines whether or not to adjust the region sizes based on the position the selected media listing is associated with. For example, in some embodiments, the media guidance application may reduce and/or expand one or more regions in order to accommodate additional information generated within that region or another region. The media guidance application may determine which regions to adjust via user input (e.g., as discussed below in relation to FIG. 2C) or based on threshold levels determined by the type of information (e.g., media guidance data and/or additional information) displayed in the region (e.g., as discussed above in relation to FIG. 1D).

If the media guidance application determines not to adjust the region sizes based on the position, the media guidance application proceeds to step 622. If the media guidance application determines to adjust the region sizes based on the position, the media guidance application adjusts the region sizes (e.g., via instruction transmitted from control circuitry 304 (FIG. 3)) at step 620, and proceeds to step 622.

At step 622, the media guidance application determines whether or not to adjust the region sizes based on the type of additional information. For example, in some embodiments, the media guidance application may reduce and/or expand one or more regions in order to accommodate the type of additional information generated within that region or another region. For example, video data may require more pixels of a display screen to display that textual data. Likewise, operation commands (e.g., additional information 142 (FIG. 1D)) may require even more pixels than either video or textual data (e.g., if the size of the operation command corresponds to an input area on a user input interface such as a touchscreen device).

If the media guidance application determines not to adjust the region sizes based on the type of additional information, the media guidance application proceeds to step 626. If the media guidance application determines to adjust the region sizes based on the type of additional information, the media guidance application adjusts the region sizes (e.g., via instruction transmitted from control circuitry 304 (FIG. 3)) at step 624, and proceeds to step 626.

At step 626, the media guidance application generates for display additional information for the selected media listing at the designated position. For example, the additional information (e.g., additional information 136 (FIG. 1D)) may be generated (e.g., via commands issued from control circuitry 304 (FIG. 3)) in a display (e.g., display 100 (FIG. 1D)) on a display screen (e.g., display 312 (FIG. 3)) of a user device (e.g., user equipment device 402, 404, and/or 406 (FIG. 4)). In some embodiments, step 626 may correspond to step 506 or 510 (FIG. 5)).

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted, the systems and/or methods described above may be applied to, or used in accordance with, other systems and/or methods.

1. A method for customizing an interactive media guide, the method comprising:
generating a plurality of media listings for display in a first region;
receiving a first user input selecting a first media listing of the plurality of media listings to associate with a first user selected position in a second region, wherein the second region is adjacent to the first region;
in response to the first user input, generating for display additional information corresponding to the first media listing at the first user selected position in the second region;
receiving a second user input selecting a second media listing of the plurality of media listings to associate with a second user selected position in the second region; and
in response to the second user input, generating for display, simultaneously with the additional information corresponding to the first media listing at the first user selected position in the second region, additional information corresponding to the second media listing at the second user selected position in the second region.

2. The method of claim 1, further comprising determining a type of the additional information corresponding to the first media listing to generate in the second region based on the first user input.

3. The method of claim 1, further comprising determining a type of the additional information corresponding to the first media listing to generate in the second region based on the first user selected position.

4. The method of claim 2, further comprising:
in response to receiving the first user input selecting the first media listing, determining a size of the second region; and
automatically resizing the first region based on the size of the second region.

5. The method of claim 2, further comprising determining a size of the second region based on a type of additional information generated for display in the second region.

6. The method of claim 1, further comprising receiving a user request to generate the second region.

7. The method of claim 1, further comprising:
receiving the additional information corresponding to the first media listing from a remote source;
storing the additional information corresponding to the first media listing; and
retrieving the additional information corresponding to the first media listing in response to the user input.

8. The method of claim 1, wherein the additional information includes previews, video clips, content descriptions, or information retrieved from remote sources.

9. The method of claim 1, wherein the first user input selecting the first media listing of the plurality of media listings to associate with the first user selected position in the second region includes dragging the first media listing from the first region and dropping the first media listing at the first user selected position in a second region.

10. The method of claim 1, wherein the first user input selecting the first media listing of the plurality of media listings to associate with the first user selected position in the second region includes dragging the first media listing from the first region and dropping the first media listing outside the first region.

11. A system for customizing an interactive media guide, the system comprising control circuitry configured to:
generate a plurality of media listings for display in a first region;
receive a first user input selecting a first media listing of the plurality of media listings to associate with a first user selected position in a second region, wherein the second region is adjacent to the first region;
in response to the first user input, generate for display additional information corresponding to the first media listing at the first user selected position in the second region;
receive a second user input selecting a second media listing of the plurality of media listings to associate with a second user selected position in the second region; and
in response to the second user input, generate for display, simultaneously with the additional information corresponding to the first media listing at the first user selected position in the second region, additional information corresponding to the second media listing at the second user selected position in the second region.

12. The system of claim 11, further comprising control circuitry configured to determine a type of the additional information corresponding to the first media listing to generate in the second region based on the first user input.

13. The system of claim 11, further comprising control circuitry configured to determine a type of the additional information corresponding to the first media listing to generate in the second region based on the first user selected position.

14. The system of claim 12, further comprising control circuitry configured to:
in response to receiving the first user input selecting the first media listing, determine a size of the second region; and
automatically resize the first region based on the size of the second region.

15. The system of claim 12, further comprising control circuitry configured to determine a size of the second region based on a type of additional information generated for display in the second region.

16. The system of claim 11, further comprising control circuitry configured to receive a user request to generate the second region.

17. The system of claim 11, further comprising control circuitry configured to:
receive the additional information corresponding to the first media listing from a remote source;
store the additional information corresponding to the first media listing; and
retrieve the additional information corresponding to the first media listing in response to the user input.

18. The system of claim 11, wherein the additional information includes previews, video clips, content descriptions, or information retrieved from remote sources.

19. The system of claim 11, wherein the first user input selecting the first media listing of the plurality of media listings to associate with the first user selected position in the second region includes dragging the first media listing from the first region and dropping the first media listing at the first user selected position in a second region.

20. The system of claim 11, wherein the first user input selecting the first media listing of the plurality of media listings to associate with the first user selected position in the second region includes dragging the first media listing from the first region and dropping the first media listing outside the first region.

21-40. (canceled)
